(19) United States
(12) Patent Application Publication
(10) Pub. No.: US 2026/0274405 A1
(43) Pub. Date: Sep. 17, 2026

(54) VERTIPORT WITH CONVEYANCE PLATFORMS

(71) Applicant: FLYON Aerosystems Ltd., Tel-Aviv (IL)

(72) Inventors: Oren TAL, Kfar-Sava (IL); Reuven TAL, Tel-Aviv (IL)

(21) Appl. No.: 19/682,629

(22) Filed: May 20, 2026

Related U.S. Application Data
(63) Continuation of application No. 19/254,489, filed on Jun. 30, 2025, now Pat. No. 12,649,570.
Application No. 19/254,489 is a continuation of application No. 19/023,615, filed on Jan. 16, 2025, now Pat. No. 12,371,160.
Application No. 19/023,615 is a continuation of application No. 18/442,225, filed on Feb. 15, 2024, now Pat. No. 12,214,873.
Application No. 18/442,225 is a continuation of application No. 18/224,084, filed on Jul. 20, 2023, now Pat. No. 12,024,278.
Application No. 18/224,084 is a continuation of application No. 18/102,741, filed on Jan. 29, 2023, now abandoned.
Application No. 18/102,741 is a continuation of application No. 16/664,913, filed on Oct. 27, 2019, now Pat. No. 11,565,801.
Application No. 16/664,913 is a continuation-in-part of application No. PCT/IL2018/050468, filed on Apr. 29, 2018.
(60) Provisional application No. 62/490,622, filed on Apr. 27, 2017.
(60) Provisional application No. 62/502,793, filed on May 8, 2017.
(60) Provisional application No. 62/572,493, filed on Oct. 15, 2017.

(51) Int. Cl. B64C 27/50; B60P 3/11; B64C 1/14; B64C 27/20; B64C 29/00; B64D 11/00; B64F 1/22; B64F 1/31

(52) U.S. Cl. CPC B64C 27/50; B60P 3/11; B64C 1/1423; B64C 27/20; B64C 29/0025; B64D 11/00; B64F 1/22; B64F 1/31

(57) ABSTRACT

A system and method for conveying and charging passenger-carrying aerial vehicles (AVs) comprising electric propulsion systems are disclosed. A conveyance platform (CP) is configured to support the full weight of an AV and convey the AV within a vertiport while at least one passenger remains inside the AV. In some embodiments, the AV lands directly on the conveyance platform and takes off directly therefrom.

Electrical energy for powered flight may be transferred to the AV through the conveyance platform while the AV is conveyed. In some embodiments, the conveyance platform transfers electrical energy from an external electrical conductor extending along at least a portion of a path of movement of the conveyance platform. The electrical conductor may comprise a rail or a cable connected to an external electrical energy source.

In some embodiments, the conveyance platform is associated with a battery configured to transfer electrical energy to the AV, optionally sufficient for one or more AV charging cycles before replenishment. A command system may coordinate movement of a plurality of conveyance platforms during a vertiport ground cycle.

### FIELD AND BACKGROUND OF THE INVENTION

The present invention relates generally to aerial vehicles (AVs) and supporting ground infrastructure therefor and, in particular, to systems and methods for handling, conveying, positioning, charging, embarking and disembarking passenger-carrying aerial vehicles, including electric vertical take-off and landing (VTOL) aerial vehicles.

In view of heavy traffic congestion in many urban areas, major efforts are being conducted worldwide to develop transportation solutions that enable bypassing ground traffic congestion. In many cases, these solutions are based on aerial vehicles with Vertical Take-Off and Landing (VTOL) capabilities, frequently powered by electric propulsion systems with electronic control.

Such aerial vehicles may enable transportation of passengers between locations without relying on conventional road infrastructure and may therefore significantly reduce travel times in dense urban and metropolitan regions.

However, large-scale deployment of such aerial vehicles presents substantial operational and infrastructure challenges. In particular, efficient handling of aerial vehicles in vertiports may become increasingly important as traffic density and passenger throughput increase.

Among the challenges associated with operation of aerial vehicles within vertiports and other ground facilities are:
movement of aerial vehicles between landing and takeoff areas and passenger areas;
charging of onboard batteries;
maintenance and buffering operations;
reduction of turnaround time;
coordination of multiple aerial vehicles; and
efficient utilization of limited ground area.

### SUMMARY OF THE INVENTION

The present invention provides systems and methods for handling an aerial vehicle (AV) within a vertiport during at least portions of the ground cycle. Handling of the AV may include, for example, conveying the AV between different locations within the vertiport and optionally providing electrical energy to the AV, including charging onboard electrical energy storage systems of the AV.

In a preferred embodiment, both conveyance and charging are performed utilizing a dedicated auxiliary structure, referred to herein as a conveyance platform (CP).

Aerial vehicles of various configurations may be utilized, including aerial vehicles comprising skids, wheels, or other landing structures. In some implementations, the CP is configured to support the full weight of the AV during conveyance within the vertiport. Such full support may be advantageous both for skidded AVs and for wheeled AVs. The CP may comprise wheeled or non-wheeled movement mechanisms. In some embodiments, the CP is self-propelled. In other embodiments, the CP is moved by an external conveyance arrangement, including for example a dedicated conveyor arrangement or other logistics arrangements. In some embodiments, the CP defines a palletized support structure configured to support and convey the AV within the vertiport.

Supporting the AV substantially or entirely by the CP may facilitate movement of the AV through different regions of the vertiport. Full support of the AV by the CP may further facilitate handling of AVs having different landing geometries.

In some embodiments, the AV lands directly on the CP and may optionally take off directly from the CP. In other embodiments, the AV is positioned on the CP following landing of the AV.

In some embodiments, electrical energy is provided to the AV while the AV remains supported by the CP. Providing electrical energy while the AV is supported by the CP may reduce turnaround time and may facilitate charging operations within the vertiport.

In some preferred embodiments, electrical energy is provided to the CP through an external electrical conductor, such as a rail or a cable, and is transferred therefrom to the AV. In some embodiments, energy to the AV is provided from a battery associated with the CP.

### BRIEF DESCRIPTION OF THE DRAWINGS

FIGS. 1a-1d illustrate the landing of an AV on a CP according to Embodiment A of the present invention.

FIGS. 2a-2c illustrate, respectively, front, side, and top views of a CP according to embodiment B of the present invention.

FIGS. 3a-3f illustrate the landing of an AV on a CP and subsequent steps, according to embodiment B of the present invention.

FIGS. 4a-4d illustrate the CP of embodiment C of the present invention.

FIGS. 5a-5d illustrate the docking process of a CP and an AV according to embodiment C of the present invention.

FIG. 6a illustrates the CP of embodiment A conveying a respective AV while transferring electrical energy thereto from a feeding rail.

FIG. 6b illustrates the CP of embodiment A conveying a respective AV while transferring electrical energy thereto from a rail.

FIGS. 7a-7b depict features of vertiport Layouts A and B, respectively.

FIGS. 8a-8b depict features of vertiport Layouts C and D according to an embodiment of the present invention.

FIGS. 9a-9e illustrate embodiment D of an AV-CP combination comprising a swappable battery carried by the CP.

FIG. 10 illustrates embodiment E of a CP configured to transfer electrical energy from a feeding rail 200 to an AV while conveying the AV.

FIG. 11 illustrates embodiment F of a CP configured to transfer electrical energy from a cable 220 to an AV while conveying the AV.

FIG. 12 illustrates embodiment G of a CP conveying an AV which is in direct contact with a cable 221 for receiving electrical energy.

FIG. 13 is a block diagram illustrating a central command system according to an embodiment of the present invention.

### DESCRIPTION OF THE PREFERRED EMBODIMENTS

### Introduction and Overview

The present disclosure provides systems and methods for handling aerial vehicles (AVs) within a vertiport during at least portions of the ground cycle. As described above, handling of the AV may include conveyance of the AV between different regions of the vertiport and provision of electrical energy to the AV. The following description presents a number of non-limiting embodiments and implementation examples of the invention.

The present disclosure provides several generic approaches for operating a vertiport. The illustrated vertiport layouts are schematic, and various modifications may be implemented, including modifications in the number, arrangement and geometry of landing areas, passenger areas, paths of movement, charging regions and maintenance regions.

According to an aspect of the present invention, a system is provided comprising a plurality of conveyance platforms (CP) moving in a coordinated motion along fixed paths of movement. Each CP fully supports the full weight of a respective AV. In some embodiments the CPs comprise wheeled movement mechanisms and are propelled from an onboard motor. In some embodiments, the CPs are non-wheeled moved by an external conveyance arrangement. In some embodiments, the CPs form a part of a conveyor arrangement configured to move the CPs within the vertiport.

The present disclosure provides several generic approaches for positioning an AV on a CP. Two embodiments (A and B) of an AV-CP combination will be illustrated where AV lands directly on a CP. A third embodiment (C) will be illustrated where the CP positions itself beneath the AV following landing of the AV and heaves the AV in an essentially vertical motion.

The present disclosure further provides multiple embodiments for providing electrical energy to AV.

In an embodiment, AV batteries are charged via the CP from external resources, for example by using an electricity conductor through which energy from an external source is provided to the CP and therefrom to the AV. The electrical conductor may comprise a rail or a cable positioned along portions of the path of movement. Such methods require additional infrastructure to provide the feeding rail or cable.

In an embodiment, AV batteries are charged from external resources via a direct contact of the AV itself with an electrical conductor such as a rail or a cable.

In an embodiment, the CP may be associated with a battery for providing the AV with electrical energy. The battery may be integral with the conveyance platform or removably coupled thereto and may be rechargeable while mounted on the conveyance platform or following replacement thereof. For operational efficiency, the battery may be configured to provide sufficient electrical energy for a full charging cycle of the AV before replenishment of the battery. In preferred embodiments, the battery is configured to provide sufficient electrical energy for a plurality of AV charging cycles before replenishment.

Since each AV is recharged on its CP, recharging is not limited to a small number of recharging sockets, which is typically the case in air terminals, and can be performed in parallel on as many CPs as are available at the vertiport. The CP in fact serves as a recharging intermediary or buffer. The AV is not required to be stationary and be attached to a socket at the recharging zone and can continue to be moved by the CP while being recharged by it.

An important advantage of the embodiments above is the robustness and the fault-tolerance of the entire system. Since recharging processes are decoupled from the grid and indeed from each other, any grid malfunction such as power outage, or recharging malfunction of any kind on a single AV, will not have an immediate effect on the overall recharging process.

It will be appreciated that the various vertiport layouts, positioning approaches, charging approaches and conveyance approaches described herein are not mutually exclusive and may be combined in various combinations and sub-combinations within the scope of the invention.

In the following description, reference is made to a plurality of figures illustrating different aspects of the invention. The figures are schematic and are provided primarily for purposes of explanation and illustration. Unless expressly stated otherwise, features illustrated in connection with one embodiment may be utilized in combination with other embodiments.

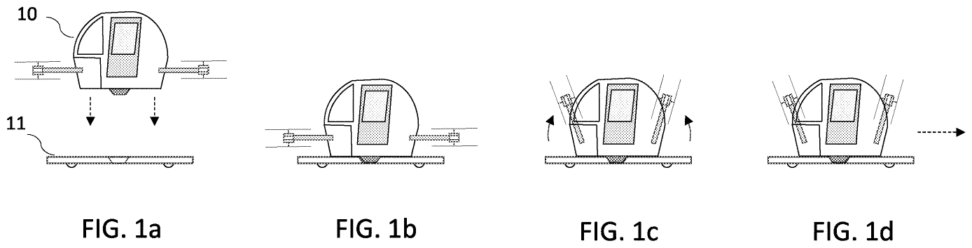

FIGS. 1a-1d illustrate Embodiment A, in which an AV 10 is conveyed by a respective CP 11. In this particular AV embodiment, the AV 10 is configured to stow its arms, thereby reducing its footprint during the ground cycle. Other embodiments exist which do not have this functionality.

FIG. 1a illustrates the AV 10 shortly before landing on the CP 11. FIG. 1b illustrates the AV 10 positioned on the CP 11 after landing. FIG. 1c illustrates the AV 10 with its arms stowed close to its body. FIG. 1d illustrates movement of the AV 10 while supported by the CP 11. The CP 11 is capable of moving, or being moved, at relatively low speeds over a flat and smooth surface. Use of such a CP in a vertiport may provide substantial advantages in reducing ground-cycle time.

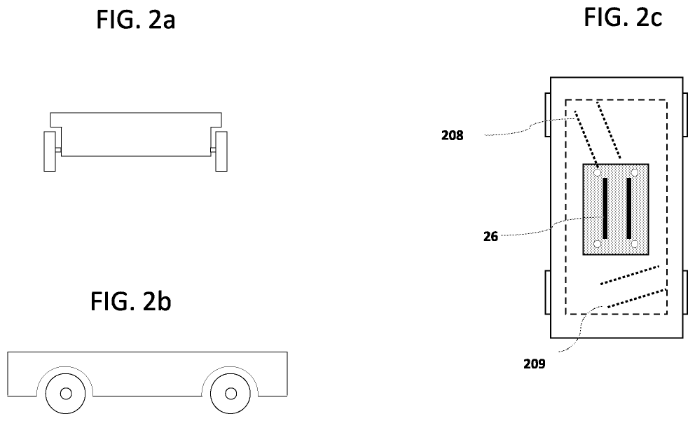

FIGS. 2a-2c illustrate, respectively, front, side, and top views of a CP according to embodiment B configured to support direct landing of an AV thereon. Targeted position 26 represents the desired landing position of the AV skids. Positions 208 and 209 illustrate exemplary actual landing positions. Deviations from the targeted position may result from a variety of guidance-error factors, including, in particular, the effects of wind gusts. As can be seen, the ground footprint of the CP is configured to provide sufficient clearance for accommodating landing-position deviations associated with the landing accuracy characteristics of the particular AV.

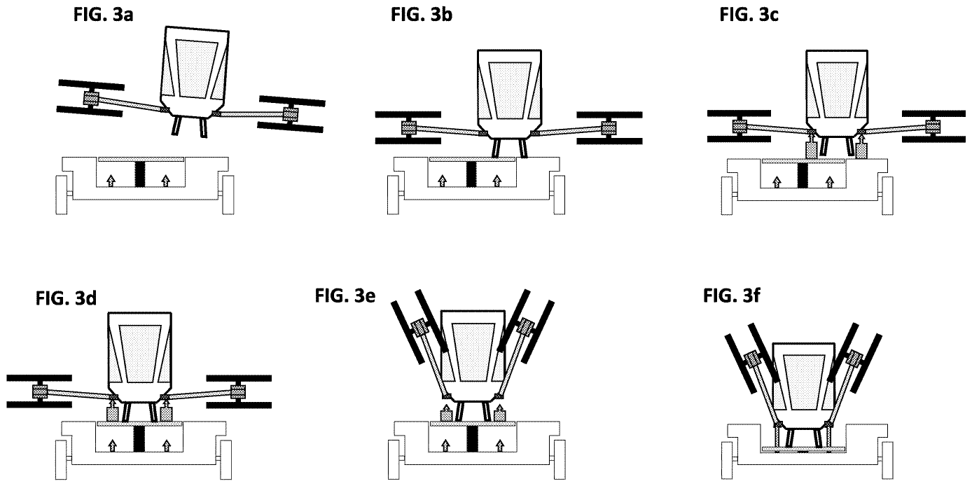

FIGS. 3a-3f illustrate embodiment B of an AV conveyed by the CP of FIG. 2a. FIGS. 3a-3b illustrate an AV landing directly on the CP. FIGS. 3c-3d depict moving the AV to an elevator platform at the center of the CP upper surface, utilizing small robots. FIG. 3e depicts stowing the arms, and FIG. 3f depicts lowering the elevator platform.

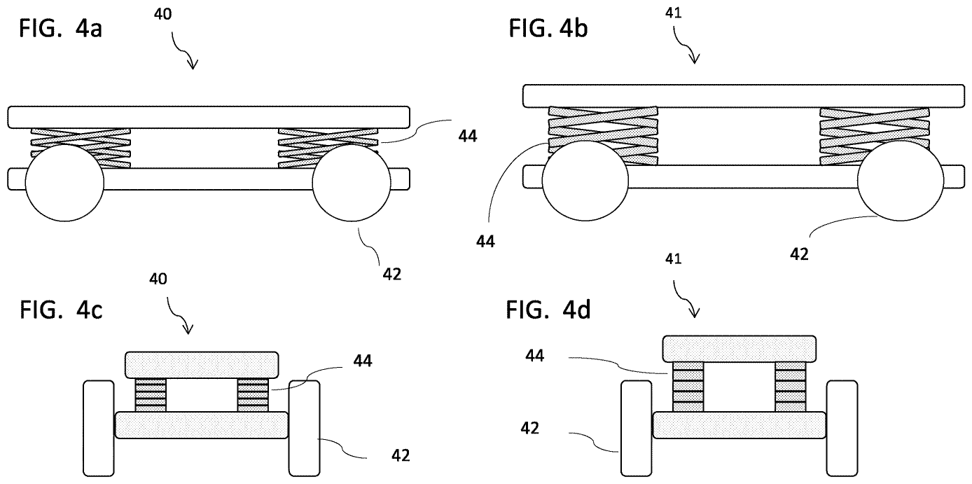

FIGS. 4a-4d illustrate Embodiment C of a CP in lowered and raised states, respectively, for use with certain embodiments of the present invention. FIGS. 4a-4b illustrate side views of the CP in a retracted (lowered) position 40 and an extended (raised) position 41, respectively. FIGS. 4c-4d illustrate front views of the CP in the retracted position 40 and the extended position 41, respectively.

The CP may comprise one or more attachment interfaces configured to facilitate convenient engagement with an AV. The CP may move, or be moved, at relatively low speeds over a generally flat and smooth surface of a vertiport.

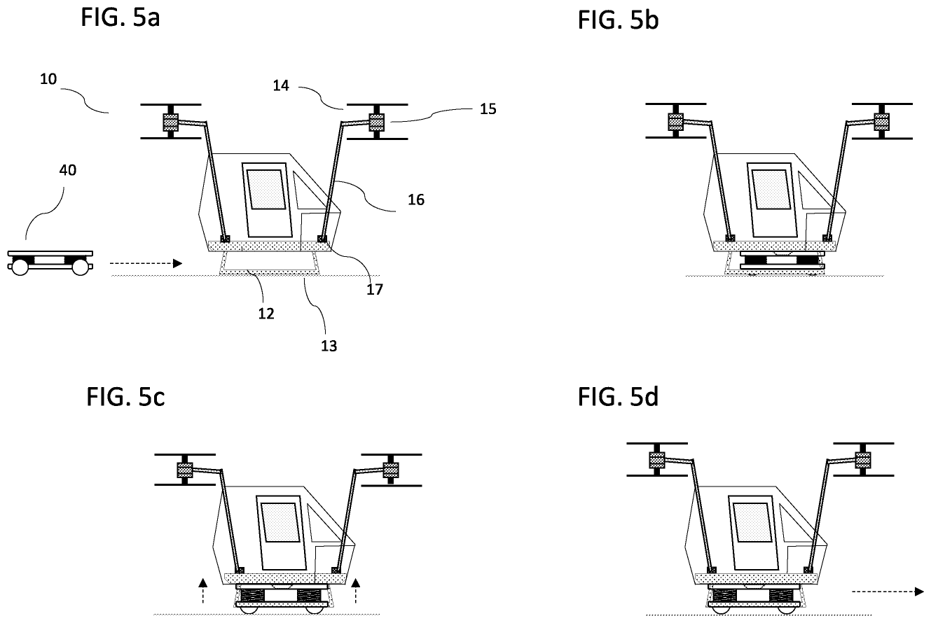

FIGS. 5a-5d illustrate the CP of embodiment C conveying a respective AV. FIG. 5a illustrates the CP in retracted position 40 approaching the AV. FIG. 5b illustrates the CP still in retracted position 40, placing itself between AV skids 13 and supporting AV belly 12. FIG. 5c illustrates the CP in extended position 41 thereby lifting AV 10. FIG. 5d illustrates the CP in extended position 41 conducting land travel with the AV 10 on top.

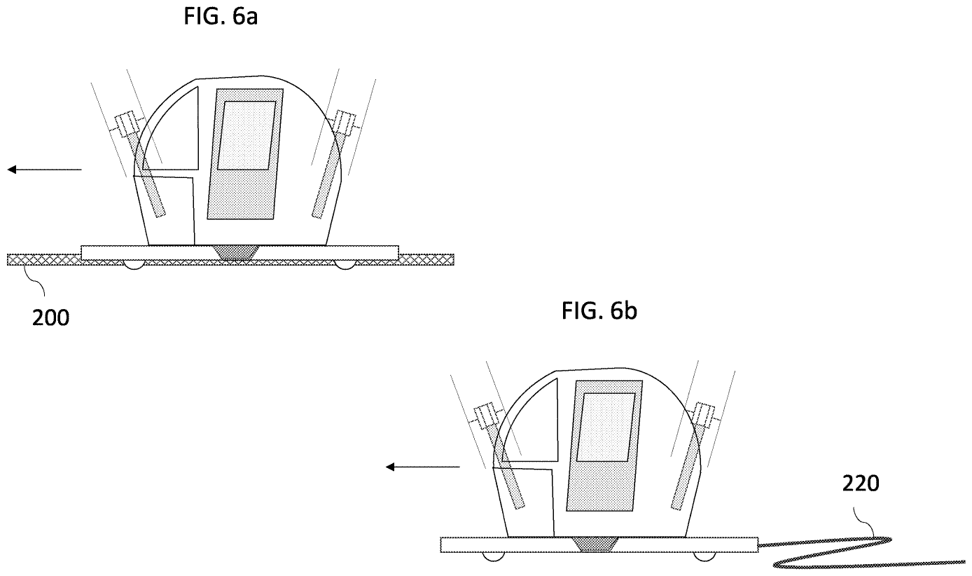

FIG. 6a illustrates the CP of embodiment A conveying a respective AV while transferring electrical energy thereto from a feeding rail.

FIG. 6b illustrates the CP of embodiment A conveying a respective AV while transferring electrical energy thereto from a rail.

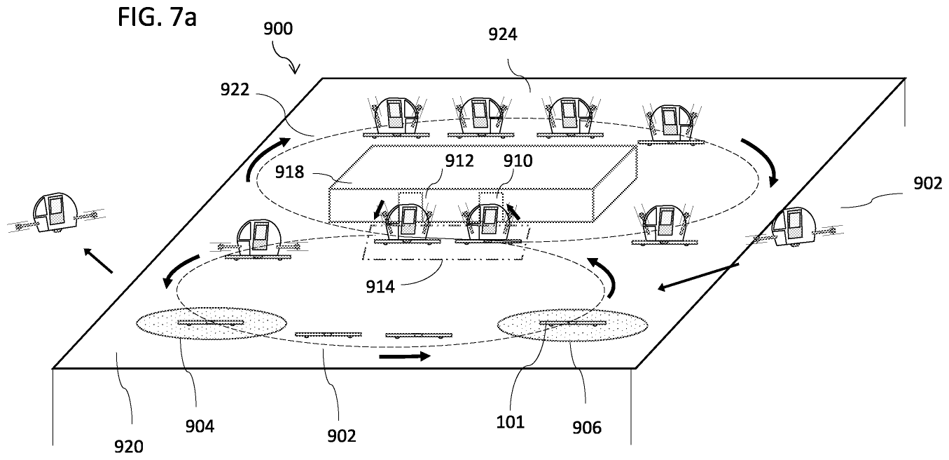

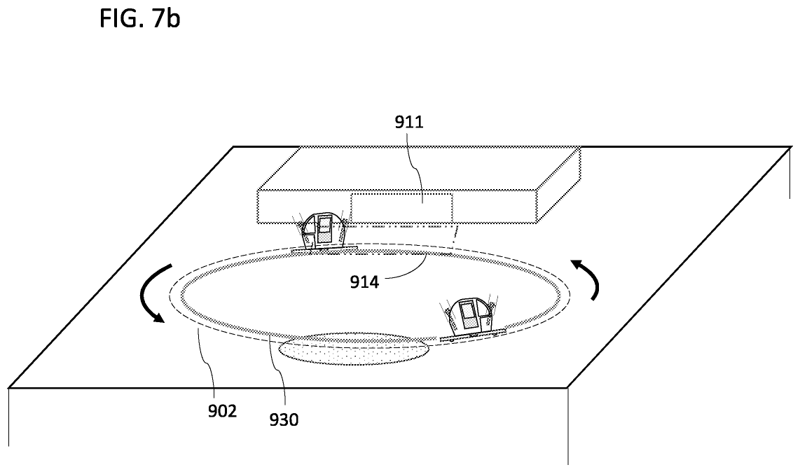

FIGS. 7a-7b depict features of particular exemplary layouts of a rooftop terminal or vertiport. As any one of embodiments A, B, or C of an AV-CP combination may be employed, embodiment A is presented in the layouts as a non-limiting example.

FIG. 7a depicts a layout of a vertiport 900 according to Layout A. The vertiport comprises an airfield 920 configured to support landings and take-offs of AVs. Although the airfield may comprise any number of landing pads, including one or more landing pads, it is schematically illustrated for clarity as comprising two pads: a take-off pad and a landing pad.

The vertiport comprises a passenger terminal 918 having two access points: an entry access point 910 for arriving passengers and an exit access point 912 for departing passengers. Disembarkation and embarkation operations are performed adjacent to the respective access points, optionally in partly overlapping areas. Collectively, these areas may be referred to as a combined disembarkation and embarkation area (CEEA) 914.

AVs are transferred in the vertiport by respective CPs along a main path of movement 902 and a secondary path of movement 904, both originating and terminating the CEEA. The main path of movement extends from the CEEA directly to the airfield 920, passing through a take-off pad 904 and a landing pad 906, and subsequently returning to the CEEA. The secondary path of movement 922 extends from the CEEA to a queueing area 924 located around the rear side of the terminal, continues around the terminal, and returns to the CEEA.

An AV 902 lands on a CP 101 positioned on a landing pad 906. It is then conveyed to the CEEA. At the CEEA, arriving passengers disembark and enter the passenger terminal at entry access point 910.

At this point, a decision is made based on one or more operational conditions. For the AV to proceed to the airfield, the AV may need to be applicable to the planned flight of one or more passengers present at the terminal. Such applicability may depend on factors including, but not limited to, the model, type, or operator of the AV. Applicability may additionally depend on the battery condition of the AV, particularly in view of the required flight range, and/or on maintenance-related considerations. In case all operational conditions are met, departing passengers board the AV and the AV is routed to the airfield via the main path of movement for take-off. Subsequently, the CP moves towards landing site to service further landing AVs.

If the above conditions are not met, the AV is routed onto a buffer zone 924. At a further point in time, when the pertinent conditions are met, the CP moves the AV from the buffer zone via the secondary path of motion back to the CEEA, and after passenger embarkation, to the take-off site 904.

It will be noted that bringing the AVs sequentially to predefined locations of one or more disembarking and boarding gates provides notable logistical and safety advantages compared to schemes requiring the passengers to approach the take-off area and/or disembark from a landing area.

In some cases, a suitable arrangement of conveyors or other logistic arrangements can be provided for moving a simple dolly (with wheels) or pallet (without wheels) on which the AV is positioned, to facilitate conveyance of the AV between the various stops in the ground cycle.

FIG. 7b provides the general outline of a vertiport according to Layout B, which is a simplified version of Layout A, focusing on the main path of movement 902 and comprising a single landing pad 905. After landing on a CP at the landing pad 905, the AV is moved to a CEEA 914 adjacent to an exit and entrance access point 911. After arriving passengers disembark and departing passengers embark, the AV is moved back to the airfield for take-off. The vertiport comprises a feeding rail 930 disposed along the path of movement and configured to be connected to a charging system (not shown). While moving along the path of movement, the CP receives electrical energy from the feeding rail and transfers the electrical energy to the AV.

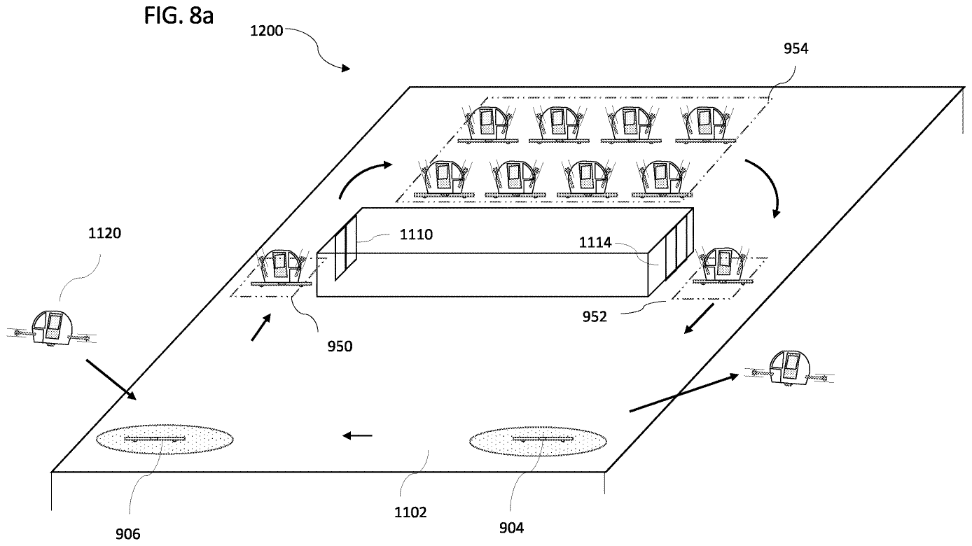

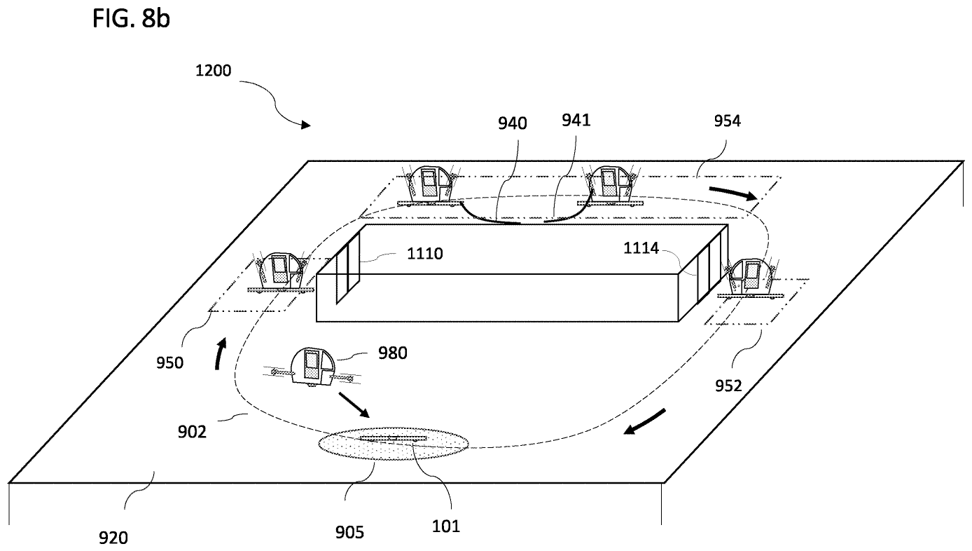

FIG. 8a provides a general outline of a vertiport 1200 according to Design C. On the flight deck 1102 there are a landing pad 906 and a take-off pad 904. An incoming AV 1120 lands on a CP positioned on the landing pad 906. The AV is conveyed to the disembarkation area 950 adjacent the entry access point of the terminal 1100.

Following disembarkation, the AV is further conveyed by the CP onto the queuing zone 954 awaiting to serve departing passengers. While in the queuing zone, the AV may be provided with energy supply for the subsequent flight. When operational conditions (as discussed for Layout A) are met, the AV is moved onto the embarkation area 952 adjacent the exit access point 1114. After passenger embarkation, the AV is conveyed onto the takeoff pad 904 for take-off.

FIG. 8b provides a general outline of a vertiport 1100 according to Layout D, which is a simplified version of Layout C comprising a single landing/take-off pad 905 and a single path of movement 902. An incoming AV 980 lands on a CP 101 positioned on the pad. After stowing its arms, the AV is moved to a disembarkation area 950 adjacent to an arrivals gate 1100, where arriving passengers disembark.

Following disembarkation, the AV is further moved by the CP onto a charging zone 954 awaiting to serve departing passengers. While moving in the charging zone, the AV may be, e. g, provided with electrical energy from a cable 940 connected thereto and configured to be connected to a charging system (not shown). In a different variation, a cable 941 is connected directly from a charging system to the AV. Once the pertinent conditions for subsequent flight (as discussed for Layout A) are met, the AV is moved onto an embarkation area 952 adjacent to the departures gate 1114 for departing passengers embarkation. After passenger embarkation, the AV is conveyed by the CP back to the airfield for take-off.

In certain implementations, the embarkation area, disembarkation area, and queueing/charging area may be located considerably apart, such as hundreds of yards. This may be the case for example at a ground vertiport where each of several AV operating companies may have its own passenger terminal and queueing zone.

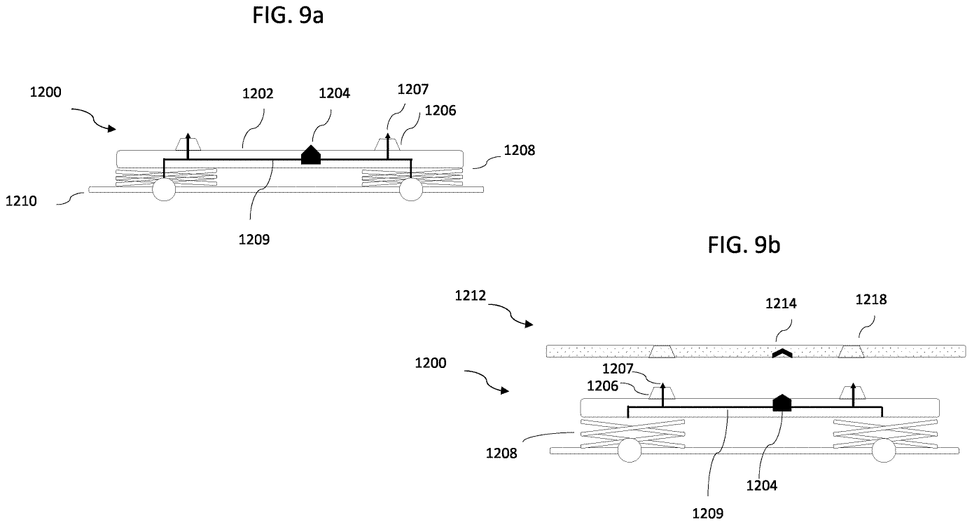

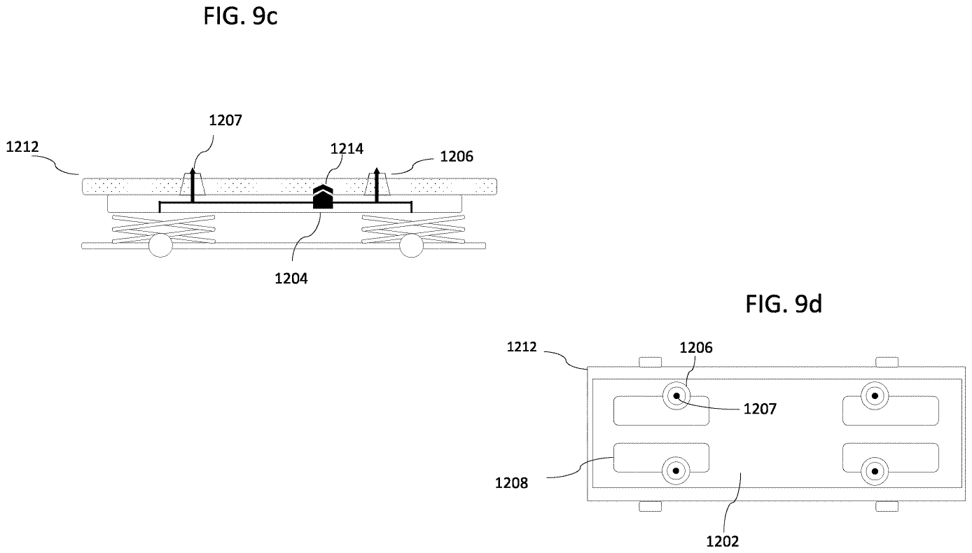

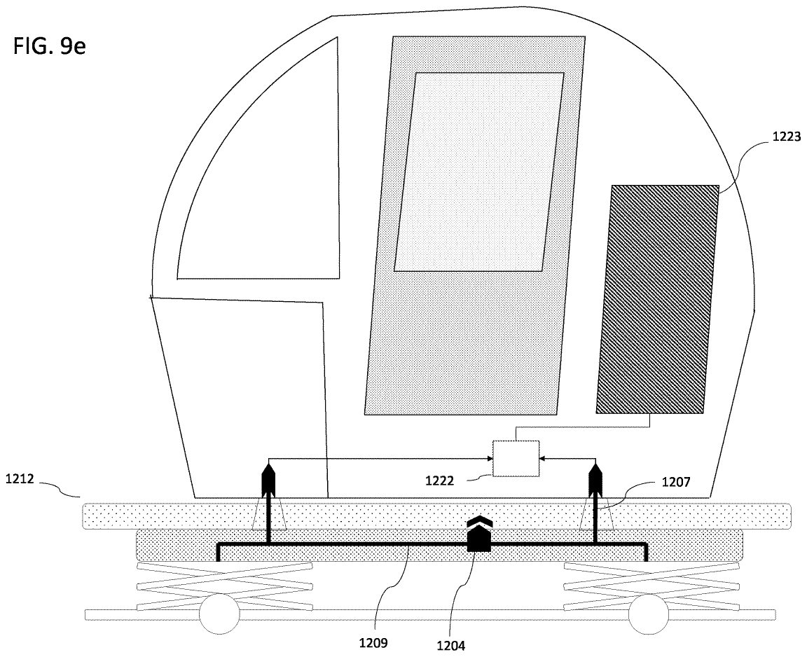

FIGS. 9a-9e illustrate embodiment D of an AV-CP combination in which the conveyance platform (CP) carries a swappable battery configured to transfer electrical energy to the AV.

FIG. 9a illustrates a side cross-section of a CP 1200 in retracted mode with no swappable battery pack coupled to it. The top plate 1202 supports four cone-shaped load-bearing structures 1206 which are used to bear the weight of the AV. Inside the load-bearing structures 1206, an electric interface 1207 is provided for delivering power from the CP to the AV. The top plate 1202 also supports an electrical interface 1204 which is used to receive power from the swappable battery pack.

FIG. 9b illustrates a side cross-section the CP 1200 in extended mode, and a side cross-section of a swappable battery pack 1212 (drawn unattached). Four holes 1218 are provided in the swappable battery pack at locations respective to structures 1206 on CP top plate. An electric interface 1214 on the swappable battery pack, through which power is delivered to the CP, is provided in a location respective to CP electric interface 1204. An electric interface 1214 on the swappable battery pack, through which power is delivered to the AV, is provided in a location respective to AV electric interface 1204. The electric interface 1204 receives power from electrical interface of the battery pack 1214 and distributes power to the CP mechanisms via a local electric network 1209. Power is distributed from the local electric network 1209 to the CP driving system, to the lifting system and also to the electric interface to the AV 1207.

FIG. 9c illustrates a side cross-section of a CP coupled to a swappable battery pack 1212. It can be seen that the load-bearing structures 1206 are inserted through the holes in the swappable battery pack 1208. It can also be seen that electric interface 1204 is coupled to an electric interface 1214 of the swappable battery pack.

FIG. 9d illustrates a top cross-section of the CP coupled to a swappable battery pack.

FIG. 9e illustrates the CP, carrying an AV. As can be seen, CP electric interfaces 1207 are coupled with AV electric interfaces 1220, allowing energy transfer from CP to AV. From AV electric interface 1220 energy is transferred to the AV power management system 1222. As can also be seen, all AV's weight is supported by CP load-bearing structures 1206 and no forces are exerted on battery pack.

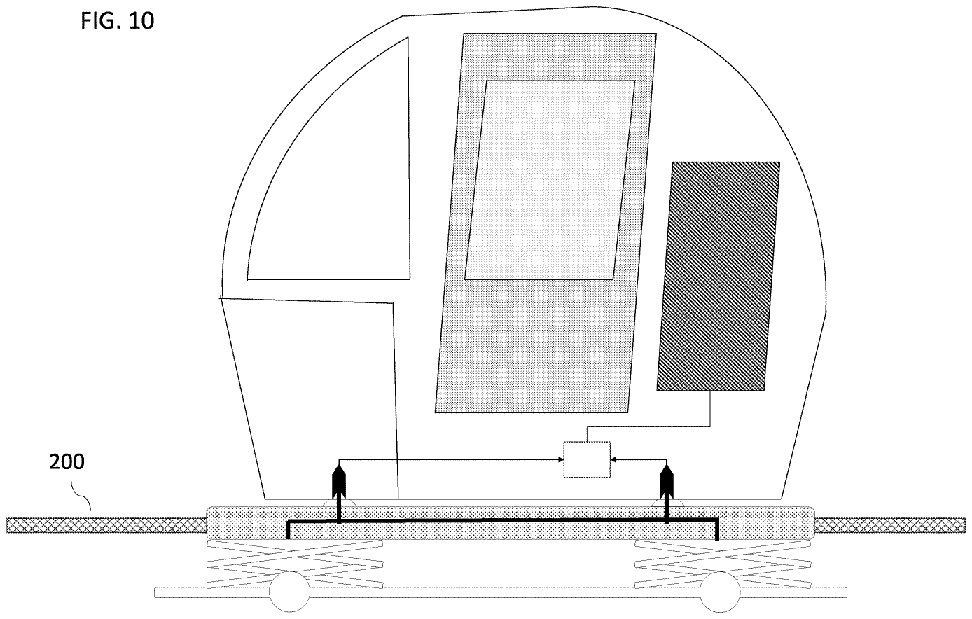

FIG. 10 illustrates embodiment E of a CP configured to transfer electrical energy from a feeding rail 200 to an AV while conveying the AV.

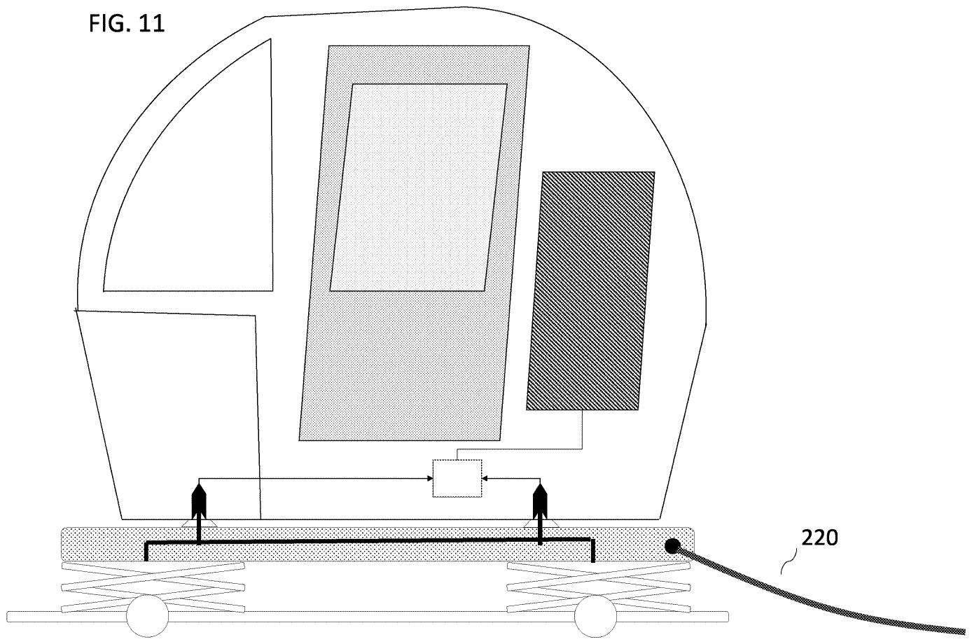

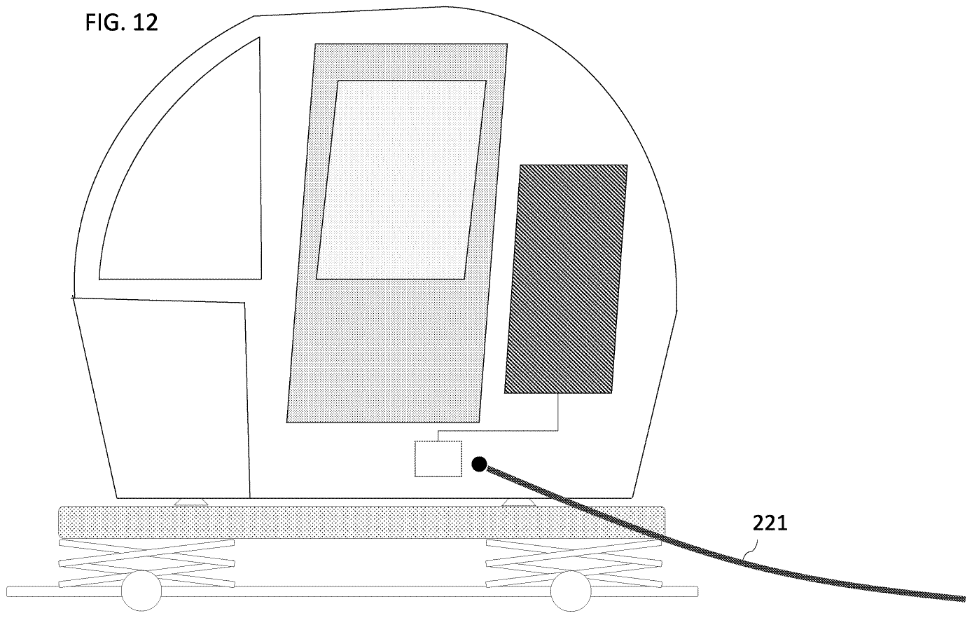

FIG. 11 illustrates embodiment F of a CP configured to transfer electrical energy from a cable 220 to an AV while conveying the AV.

FIG. 12 illustrates embodiment G of a CP conveying an AV which is in direct contact with a cable 221 for receiving electrical energy.

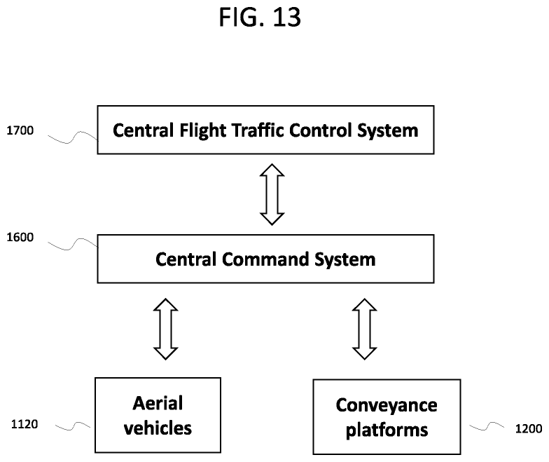

The entire handling of the AV at the Vertiport from touch-down to take-off is controlled by a central command system (1600 in FIG. 13), including a central computer, which has communications interfaces with AVs 1120, CPs 1200, all as mentioned above. The central command system also has a secure communications connection to the Central Flight Traffic Control System 1700 for coordinating the landings of arriving AVs and take-offs of departing AVs.

As extensively described above, the central command system is preferably configured to autonomously synchronize movement of the plurality of conveyance platforms based on at least one of:
(a) demand for flights;
(b) charging condition of batteries associated with the AVs;
(c) type of each AV;
(d) operating company of each AV;
(e) maintenance data associated with the AVs;
(f) data received from a flight traffic control system; and
(g) occupancy of embarkation areas, disembarkation areas, and combined embarkation and disembarkation areas.

It should be noted that the various embodiments and implementations of the invention described herein are not mutually exclusive, and that features described in the context of one implementation may be combined with any and all features of another implementation, all as will be clear to a person ordinarily skilled in the art.

It will be appreciated that the above descriptions are intended only to serve as examples, and that many other embodiments are possible within the scope of the present invention as defined in the appended claims.

It will be appreciated that the above descriptions are intended only to serve as examples, and that many other embodiments are possible within the scope of the present invention as defined in the appended claims.

What is claimed is:

1. A vertiport for passenger-carrying aerial vehicles (AVs), the AVs comprising electric propulsion systems, the vertiport comprising:
(a) an airfield;
(b) a passenger terminal comprising:
separate embarkation and disembarkation areas; or
a combined embarkation and disembarkation area;
(c) at least one path of movement extending between at least two of:
(i) the airfield;
(ii) an embarkation area;
(iii) a disembarkation area; and
(iv) a combined embarkation and disembarkation area; and
(d) a conveyance system comprising:
(i) a plurality of conveyance platforms, each conveyance platform configured to:
support the full weight of an AV; and
convey the AV along the at least one path of movement while at least one passenger is inside the AV; and
(ii) a command system configured to control movement of the plurality of conveyance platforms,
wherein the command system is configured to synchronize movement of the plurality of conveyance platforms along the at least one path of movement as part of a vertiport ground cycle.

2. The vertiport of claim 1, wherein at least one of said conveyance platforms is configured to receive landing of an AV directly thereon.

3. The vertiport of claim 1, wherein at least one of the conveyance platforms is configured to receive the AV following landing of the AV on an external surface or to transfer the AV to an external surface before takeoff.

4. The vertiport of claim 1, wherein the command system is configured to autonomously synchronize movement of the plurality of conveyance platforms based on at least one of:
(a) demand for flights;
(b) charging condition of batteries associated with the AVs;
(c) type of each AV;
(d) operating company of each AV;
(e) maintenance data associated with the AVs;
(f) data received from a flight traffic control system; and
(g) occupancy of embarkation areas, disembarkation areas, and combined embarkation and disembarkation areas.

5. The vertiport of claim 1, further comprising a charging system configured to provide electrical energy for powered flight to at least one AV while the AV is conveyed by a conveyance platform.

6. The vertiport of claim 5, wherein at least one conveyance platform is associated with a battery configured to transfer electrical energy for powered flight to a respective AV.

7. The vertiport of claim 5, further comprising a rail or cable for providing electrical energy to the AV while the AV is conveyed by a conveyance platform.

8. The vertiport of claim 7, wherein at least one conveyance platform is configured to transfer electrical energy to the AV from said rail or cable.

9. The vertiport of claim 8, wherein said at least one conveyance platform comprises:
(a) a first electrical interface configured to receive electrical energy from said rail or cable; and
(b) a second electrical interface configured to provide electrical energy to the AV, thereby transferring electrical energy from said rail or cable to the AV via the conveyance platform.

10. The vertiport of claim 1, wherein at least one of said conveyance platforms is self-propelled.

11. The vertiport of claim 1, wherein at least one of said conveyance platforms is a wheeled dolly.

12. The vertiport of claim 1, wherein at least one of said conveyance platforms is an unwheeled pallet.

13. A method for operating a vertiport for passenger-carrying aerial vehicles (AVs), the AVs comprising electric propulsion systems, the method comprising:
(a) receiving at least one AV at an airfield of the vertiport;
(b) conveying the AV throughout the vertiport by a conveyance platform, wherein the conveyance platform supports the full weight of the AV while at least one passenger is inside the AV; and
(c) synchronizing movement of a plurality of conveyance platforms.

14. The method of claim 13, comprising receiving landing of the AV directly on the conveyance platform.

15. The method of claim 13, comprising receiving the AV on the conveyance platform following landing of the AV on an external surface or transferring the AV from the conveyance platform to an external surface before takeoff.

16. The method of claim 13, wherein synchronizing movement of the plurality of conveyance platforms is based on at least one of:
(a) demand for flights;
(b) charging condition of batteries associated with the AVs;
(c) type of each AV;
(d) operating company of each AV;
(e) maintenance data associated with the AVs;
(f) data received from a flight traffic control system; and
(g) occupancy of embarkation areas, disembarkation areas, and combined embarkation and disembarkation areas.

17. The method of claim 13, comprising providing electrical energy for powered flight to at least one AV while the AV is conveyed by the conveyance platform.

18. The method of claim 17, wherein the conveyance platform is associated with a battery configured to transfer electrical energy for powered flight to a respective AV.

19. The method of claim 17, comprising providing electrical energy for powered flight to the AV via a rail or cable while the AV is conveyed by the conveyance platform.

20. The method of claim 19, wherein electrical energy is transferred from said rail or cable to the AV via the conveyance platform.

21. The method of claim 20, comprising:
(a) receiving electrical energy from said rail or cable by a first electrical interface of the conveyance platform; and
(b) providing electrical energy to the AV by a second electrical interface of the conveyance platform,
thereby transferring electrical energy from said rail or cable to the AV via the conveyance platform.

22. The method of claim 13, wherein at least one of said conveyance platforms is self-propelled.

23. The method of claim 13, wherein at least one of said conveyance platforms is a wheeled dolly.

24. The method of claim 13, wherein at least one of said conveyance platforms is an unwheeled pallet.
